(19) United States
(12) Patent Application Publication
(10) Pub. No.: US 2015/0167892 A1
(43) Pub. Date: Jun. 18, 2015

(54) SYSTEM FOR STORING ENERGY IN THE FORM OF COMPRESSED AIR IN A SET OF SURFACE TUBES

(71) Applicant: IFP Energies nouvelles, Rueil-Malmaison Cedex (FR)

(72) Inventor: Christian WITTRISCH, RUEIL MALMAISON (FR)

(21) Appl. No.: 14/570,101

(22) Filed: Dec. 15, 2014

(30) Foreign Application Priority Data
Dec. 17, 2013 (FR) 13/62.753

(51) Int. Cl. F17C 1/12; F17C 1/00

(52) U.S. Cl. CPC F17C 1/12; F17C 1/007; F17C 2201/0138; F17C 2203/0304

(57) ABSTRACT

The present invention concerns a system for storing energy in the form of compressed air, characterized in that it is made up of a set of straight or wound steel tubes (1) assembled to form a storage volume arranged at the surface, or in a subsurface, the assembly being enclosed in a thermally insulating envelope (2).

The field of the present invention concerns compressed-air energy storage (CAES). The invention relates to an optimized system for storing air.

In this system, energy, which may come from electricity obtained from renewable sources, and which it is desired to use at another time, can be stored in the form of compressed air. The electricity produced in excess therefore supplies one or more compressors aimed at compressing a given quantity of air and storing it in suitable reservoirs.

There does not exist to this day any semi-massive local storage of industrial compressed air in an artificial reservoir (apart from existing geological storage in salt chambers) between 70 and 120 bar for volumes between 1000 m³ and 30 000 m³ installed on land, at the surface or in a subsurface (hereinafter designated as “mini CAES”).

Thus, the present invention concerns a system for storing energy in the form of compressed air, characterized in that it is made up of an assembly of steel tubes connected to form a storage volume arranged at the surface, or in a subsurface, said assembly being confined in a thermally insulating envelope.

The assembly may be made up of lengths of straight tubes combined in bundles and arranged in parallel.

The assembly may be made up of at least one continuous tube wound in a reel.

The storage volume may comprise a plurality of assemblies confined in a safety and environmental protection envelope.

The system may comprise means for heating or maintaining the heat of the stored compressed air.

The storage volume may be contained in a trench formed in the ground.

The present invention will be better understood and its advantages will become more clearly apparent on reading the following nonlimiting embodiments illustrated by the figures appended hereinbelow, in which:

FIG. 1 illustrates schematically in section an assembly of “bundled” straight steel tubes in an insulating envelope,

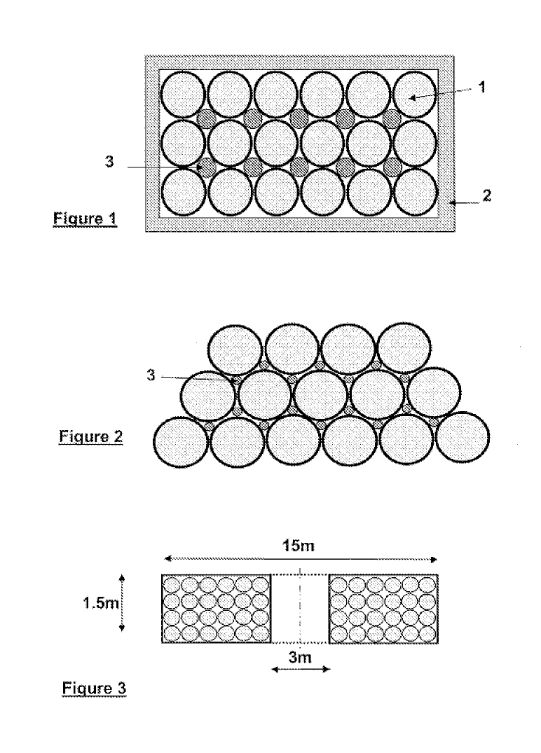

FIG. 2 shows an arrangement of heating and/or heat-recovery pipes,

FIG. 3 illustrates an example of the dimensions of a storage reel according to the invention,

FIG. 4 schematically shows the embodiments of reels with a vertical axis and with a horizontal axis and arrangements for assembling reels,

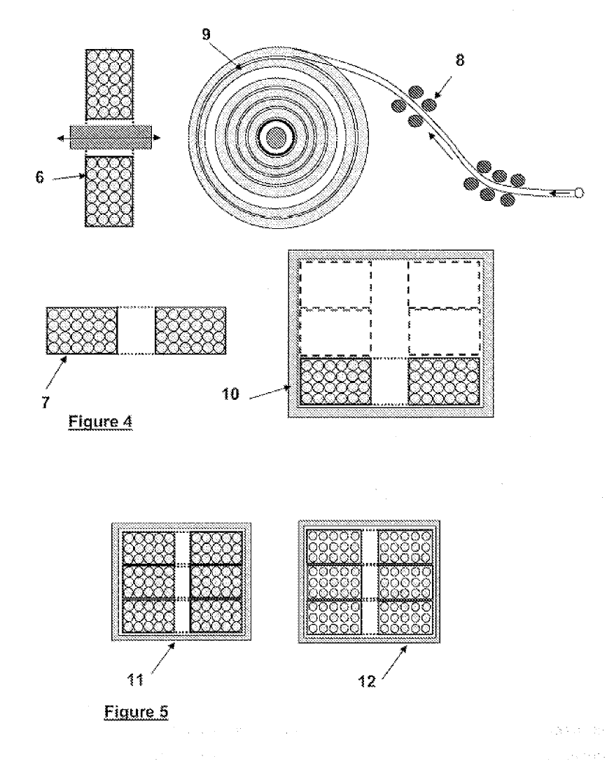

FIG. 5 illustrates the principle of a storage reel for air compressed at ambient temperature or at compression temperature.

Air at high pressure, for example between 70 and 120 bar, is stored in steel tubes assembled by welding and arranged horizontally in bundles at the surface or semi-buried in order to benefit from a more temperature-stable environment and/or for esthetic, environmental and safety reasons. The steel tubes are preferably arranged horizontally for greater ease of assembly over a greater length and to reduce the number of end caps and connections between tubes.

In order to produce this storage system, it is possible to use petroleum tubes of “weldless” type (petroleum tubing or casing type) or straight tubes welded with longitudinal welds or coil tubes used for gas pipelines, within the limit of their service pressure.

These tubes can be protected against exterior corrosion by polyolefin, polyethylene (PE) or polypropylene (PP) coatings and against interior corrosion by epoxy coatings.

The tubes, as a unit element of 12-15 meters, are preferably assembled and welded on the storage site, with limited handling means.

The lengths may reach several tens of meters as a function of the desired air volume and of the space on the storage site. The lengths of tubes thus formed are arranged in parallel then placed in successive layers to form a “bundle” of, for example, 10 per row and 10 in height, that is to say to reach a hundred tubes.

The lengths of tubes are connected to one another by ducts of suitable diameter to place them in communication, in parallel or in series, in order to obtain the chosen storage volume. A valve set on these ducts makes it possible to isolate a length or a set of tubes.

The “bundle” formed is preferably quasi-horizontal, with, however, a slight slope to facilitate the flow of condensates.

The tubes are preferably arranged horizontally rather than vertically. Horizontally, they make it possible to obtain a greater storage volume with a minimum of connection pipes and of caps at the ends of the tubes, contrary to the vertical and partially buried arrangement, which involves limiting the tube length to the depth of the excavation. The multiplication of the vertical tubes increases the number of end caps, complicates the connection, and increases the installation costs.

Example of Order of Magnitude:

For a tube of outside diameter of 20″ (0.508 m), of inside diameter 0.485 m, length 10 m, bundle of 10×10=100 tubes. The weight is 137 metric tons for a compressed air volume of 185 m³, which gives a ratio m³ of air/steel weight of 1.348 or the ratio of 0.742 metric tons of steel/m³ stored. This calculation does not take into account the end-pieces of the tubes and the means of connection between them. For this reason, the rule of “one kilo of steel for one liter of stored compressed air” can be applied.

In one variant according to the invention, if the stored air is hot (heat obtained from the compression phase), the objective is to keep for as long as possible the heat of the compressed air in the storage tubes. For that purpose, the vessel containing the bundles of assembled straight tubes is thermally insulated from the outside environment in order to keep the heat of the compressed air introduced into the store. FIG. 1 shows the section of a bundle formed of parallel tubes (1) enclosed in an enclosure (2) for thermal, environmental and/or safety insulation.

Additional heating of the air contained in horizontal straight tubes can take place from the inside or from the outside of the storage tube.

There is the possibility of arranging, in each storage tube, a tube, or “insert”, filled with a heat-storage material. However, with this system, there will be a stored air volume reduction equal to the volume of the heat-storage tubes or heating tubes.

Another variant is to use a heat exchanger composed of pipes (3) arranged in the space available between the compressed-air storage tubes. The tubes are preferably in metal-metal contact to facilitate transfer of heat by conduction. FIG. 2 shows another arrangement of the parallel tubes and of the heat-exchange pipes (3).

Heating or maintaining the temperature of the compressed air contained in the storage tube is obtained by the circulation of a hot fluid, of steam or a heat-transfer liquid which, by thermal conductivity of the steel between the two types of tubes (compressed-air tubes and hot-fluid duct), exchanges heat with the stored compressed air.

Another embodiment for storing compressed gas consists in forming reels from steel tubes, preferably, but not necessarily, on the actual site on account of their bulk: dimensions of the reels, weight, and available handling means.

The manufacture of the unit reel can be achieved by winding, with plastic deformation of the steel tube, in successive layers on a drum with a horizontal axis or with a vertical axis.

Preferably, the axis of the reel is vertical.

Example of Order of Magnitude:

A unit storage reel of maximum diameter 15 m, minimum diameter 3 m, of width 1.5 m, with a tube of diameter 6.625″ (16 cm), thickness 6.4 mm, has a steel weight of 230 metric tons, a gas storage volume of 176 m³. The volume of the cylinder formed by such an elementary reel is 276 m³ (FIG. 3) .

FIG. 4 schematically shows a reel with a horizontal axis (6) and a reel with a vertical axis (7).

The reels are manufactured from sections of standard steel tubes with a unit length of 12-15 m, assembled and welded to form a continuous tube which will then be bent in its plastic mode by means of pressing rollers (8) and wound on a specific drum (9) to form an elementary reel, for example with a volume of 276 m³.

A plurality of unit reels can be superposed then interconnected by pipes to form a storage volume in a vessel (FIG. 4).

The size of the manufactured reel and therefore its weight is directly dependent on the lifting capacity on the site of the mini CAES. Each reel element can be manufactured on site, hooped then turned over to pass from a vertical reel (with its axis horizontal) to a horizontal reel (with its axis vertical), then positioned, lowered and placed flat at the bottom of the previously constructed vessel (10) (FIG. 4).

An excavation may be produced to contain the bottom half of the drum in order to avoid a high structure and facilitate the reeling of the continuous tube.

A gantry compatible with the loads and dimensions of the reel (example: outside diameter 15 m, height 3 m, weight of the reel 230 metric tons) will allow the tilting, its displacement and the lowering of the reel in the vessel.

It will be possible to manufacture reel elements with a smaller height (for example 2 m) while retaining an acceptable outside diameter (for example 15 m) to maintain the linear volume and to reduce the mass of the manufactured element.

The reel elements will thus be stacked on one another and connected by means of tubes so as to be placed in series or parallel.

The compressed-air storage tubes can be, during the construction of the reel, contiguous (11) (contiguous turns) or slightly spaced (12) by a few centimeters between each tube to facilitate heat exchanges between the steel of the tube and the heat-transfer fluid if the air is stored hot (FIG. 5).

1. System for storing energy in the form of compressed air, characterized in that it is made up of an assembly of steel tubes connected to form a storage volume arranged at the surface, or in a subsurface, said assembly being confined in a thermally insulating envelope.

2. Storage system according to claim 1, in which said assembly is made up of lengths of straight tubes combined in bundles and arranged in parallel.

3. Storage system according to claim 1, in which said assembly is made up of at least one continuous tube wound in a reel.

4. Storage system according to claim 1, in which said storage volume comprises a plurality of assemblies confined in a safety and environmental protection envelope.

5. Storage system according to claim 1, comprising means for heating or maintaining the heat of the stored compressed air.

6. Storage system according to claim 1, in which said storage volume is contained in a trench formed in the ground.
